(19) United States
(12) Patent Application Publication
(10) Pub. No.: US 2005/0071273 A1
(43) Pub. Date: Mar. 31, 2005

(54) Method and Apparatus for Feature Rights Management in a Multilevel Hierarchy

(75) Inventors: William Vroman, Ingleside, IL (US); Marko W. Pfaff, South Elgin, IL (US); Christian Rigg, South Elgin, IL (US); Ching Kung, Mount Prospect, IL (US); Himanshu Shekhar, Palatine, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTSTARCOM, INC., Alameda, CA (US)

(21) Appl. No.: 10/605,376

(22) Filed: Sep. 25, 2003

(51) Int. Cl. G06F 17/60; H04L 9/00; H04K 1/00

(52) U.S. Cl. 705/51

(57) ABSTRACT

A multilevel hierarchical feature rights management system (100) provides an efficient way of allocating feature keys. Sub-agents (140) are provisioned or activated with application software having features. The sub-agents request permissions from feature rights management agents (120) to use these features. The feature rights management agents (120) receive feature keys over a network (130) from a feature rights server (110). The feature rights management agents (120) then permit sub-agents (140) to use their provisioned features. In a further aspect of the invention the sub-agents (140) voluntarily release feature permissions rather than the server (110) or the agents (120) forcing the sub-agents (140) to revoke rights.

### BACKGROUND OF INVENTION

1. Technical Field

The present invention relates to feature rights management and, more particularly, relates to the multilevel hierarchy for management and distribution of feature rights.

2. Description of the Related Art

Systems have been known for activating digital rights such as in software using digital keys. Digital keys have been used to allow installation of a software application at the time of software installation. Digital keys have also been used to encode classes of rights for digital media file such as music. Digital key mechanisms have also been used to unlock certain features in software applications.

An example of a digital key mechanism used to unlock certain features in software applications is the Total Control 1000 WAN HUB Network Management Card by U.S. Robotics. The U.S. Robotics Total Control 1000 provided for feature upgrades to network management and application cards. Examples of the features to be upgraded were dial security and cellular support as well as future features upgrades. The Total Control 1000 was a chassis consisting of one network management card and up to 16 application cards, each application card providing, for example, analog modem dial-up access lines for an internet service provider ISP. The analog modems on each network application card had features enabled by keys. The Total Control 1000 chassis was capable of receiving keys from a management application connected through a serial port. The management application sent their feature keys over a Simple Network Management Protocol SNMP channel. These keys were input directly to a card in the Total Control 1000 chassis by a technician. Each key was constructed using the serial number of the destination card, so that it would be tied directly to a serial number of the card which the feature is destined. The Total Control 1000 keys could not be reassigned to other cards. This made card replacement maintenance difficult because keys could not be reused.

A way of automatically managing feature permissions during maintenance on site at chassis is needed. What is also needed is a way for an operator to manage the distribution of keys without the keys being tied to specific cards yet not require communications with a remote server every time a card or feature was configured in the field in a facility. It is also desired to distribute feature permissions more efficiently using authenticated keys. A more efficient way of allocating feature keys for an equipment operator among different facilities and multiple chassis of an operator is needed.

### SUMMARY OF INVENTION

A multilevel hierarchical feature rights management system provides an efficient way of allocating feature keys for an equipment operator among different facilities and application equipment is provided. The feature rights management system has a feature rights server with a repository for storing feature keys, the feature keys representing activation rights for features. A feature rights management agent receives feature keys from the feature rights server, stores feature rights in a repository, and identifies available feature units. A sub-agent requests feature rights from the feature rights management agent. The feature rights management agent allocates the feature units among requesting sub-agents.

The details of the preferred embodiments of the invention will be readily understood from the following detailed description when read in conjunction with the accompanying drawings wherein:

### BRIEF DESCRIPTION OF DRAWINGS

FIG. 1 illustrates a block diagram of the multilevel hierarchy of the feature rights management system of the present invention;

FIG. 2 illustrates a diagram of an embodiment of the present invention having a plurality of application cards, at least one system manager card and a feature rights server;

FIG. 3 illustrates a diagram of an example of a feature key file containing the feature keys of the present invention;

FIG. 4 illustrates a flowchart of a method where a sub-agent requests feature permissions from a feature rights management agent;

FIG. 5 illustrates a flowchart of a method where a feature rights management agent requests feature keys from a feature rights server;

FIG. 6 illustrates a flowchart of a method where a sub-agent releases feature permissions to a feature rights management agent; and

FIG. 7 illustrates a flowchart of a method where a feature rights management agent releases feature keys to a server.

### DETAILED DESCRIPTION

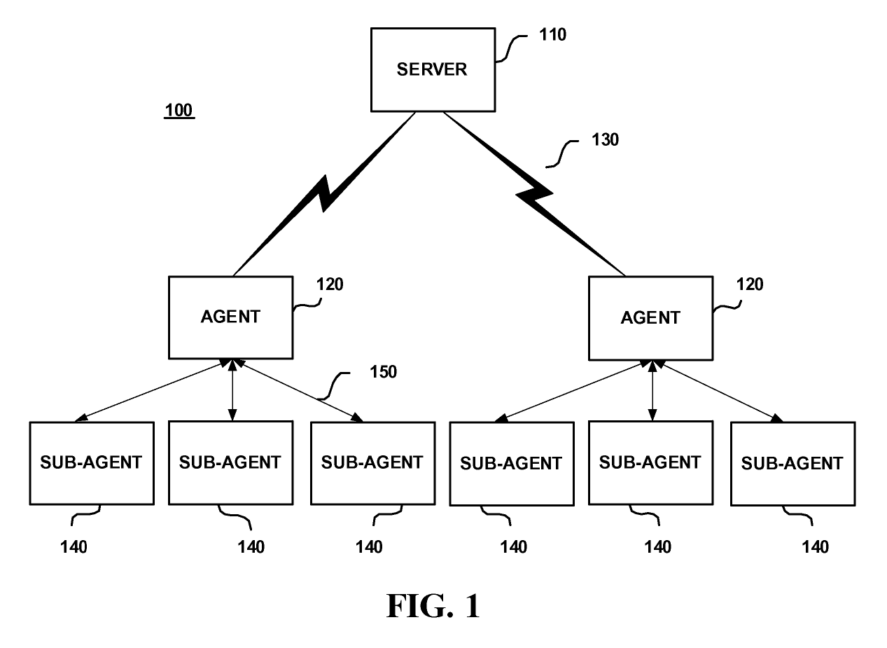

FIG. 1 illustrates a block diagram of the multilevel hierarchy of the feature rights management system 100 of the present invention. A number of feature rights management agents 120 are coupled over a network 130 to a feature rights server 110. The feature rights server 110 contains a memory for storing network feature keys. Each network feature key represents rights for features that are stored in the feature rights management server 110 for subsequent allocation to any feature rights management agent 120 in the operator's network.

A plurality of sub-agents 140 are connected over a bus 150 to its corresponding feature rights management agent 120. In a telecommunications deployment, each feature rights management agent 120 is typically located in one facility among a plurality of sub-agents 140. A plurality of sub-agents 140 can be located in a single chassis and share a common bus on a backplane of a chassis or the plurality of sub-agents 140 can be located in multiple chassis all communicating with a single feature rights management agent 120 over a networked bus such as an ethernet bus. The plurality of sub-agents 140 and corresponding agents 120 can even be connected over a networked bus rather than a backplane bus without any chassis. This arrangement might exist within a single general purpose computing platform such as a UNIX server when the capabilities of a single server can support the application demands of a system.

An operator obtains feature keys, designated as network keys, from an equipment provider and stores these feature keys in the feature rights server 110. Each feature key designates a kind of feature, a number of permissible units for that feature, and a destination ID such as a serial number for the server to which the feature is permitted. Each kind of feature can designate a single feature or preferably groups of features. Element keys are also generated by the server 110 with a designation of a kind of feature, a number of permissible units for that feature, and a destination ID such as a serial number for the agent to which the feature is permitted. A digital authentication signature is also contained in each feature key regardless of whether or not it is a network key or an element key. The feature rights server 110 is a repository for feature keys which have not yet been used to activate features.

An example of a feature to be permitted is prepaid billing. Telecommunication calls are typically billed after a call is made. A new kind of payment for telecommunications calls occurs in advance. This prepaid billing feature can be set up as a feature requiring a feature key before a prepaid billing feature is permitted in the software of the sub-agent 140. The number of permissible units for this feature would designate the number of application cards that are permitted to use this prepaid billing feature. Alternatively the number of permissible units for this feature can designate the number of simultaneous telephone calls that are permitted using this prepaid billing feature.

When an operator desires to provision or activate equipment, activation of the equipment is initiated in the facility at a sub-agent 140. The sub-agent 140 then requests permission from the feature rights management agent 120 to activate a kind of feature and a requested number of units for that feature. The feature rights management agent 120, upon receiving a request from a sub-agent 140, checks to see a number of available feature units for a particular feature stored in its memory. If the feature rights management agent 120 needs more rights than are stored in its memory, the agent 120 sends a request to the feature rights server 110 to obtain more feature keys. The feature rights server 110 then subtracts units from its available feature keys, assembles element keys and sends these thus assembled element feature keys to the requesting feature rights management agent 120. The feature rights management agent 120 then subtracts units from its available allocation of feature units and sends an authorization to the requesting sub-agent 140.

For a telecommunications application feature, when a sub-agent 140 is on standby between calls, its feature rights are retained within the sub-agent. When a sub-agent is re-provisioned or re-activated, such as when an application card is replaced or redeployed, its feature rights can be released from the sub-agent 140 to the feature rights management agent 120. The agent 120 stores those rights for redeployment to other sub-agents 140 or release to the feature rights server 110. When the feature rights management agent 120 stores rights for redeployment, the feature rights management agent 120 can store the rights for redeployment to any sub-agent 140. In the case of a chassis arrangement, when an application card sub-agent is replaced in a slot of a chassis, unless the chassis has been re-provisioned, rather than store the rights for redeployment to any sub-agent 140, it is desired for the feature rights management agent 120 to store those rights associated with the slot in the chassis. Then, when a replacement application card arrives in the slot, the same rights are allocated to that sub-agent.

The agent 120 and the sub-agent 140 do not require authenticated keys in order to authorize features for operation in the sub-agents 140. While the connection between the feature rights server 110 and the plurality of agents 120 requires authenticated keys, the relationship between the plurality of sub-agents 140 and its respective agent 120 is a trusted relationship and does not require authenticated keys. The agent 120 allocates rights among its sub-agents 140 as needed without an accounting to the feature rights server 110 other than the number of units and kind of features activated. The feature rights server 110 still knows which agents 120 obtained rights.

It is not currently contemplated, however, that the feature rights server 110 has the power to revoke rights, nor is it contemplated that the feature rights management agents 120 have the power to revoke rights. Rather, rights are released voluntarily by the sub-agents 140 and returned back to their respective feature rights management agents 120 when no longer needed. The sub-agents 140 release rights when no longer needed to perform its provisioned operation. Provisioning of the sub-agents 140 occurs by operator intervention over a protocol or command line interface. The feature rights server 110 does not re-provision the feature rights management agents or sub-agents or require release of rights. Once provisioned, sub-agents request keys to activate features via the multilevel hierarchy of the present invention.

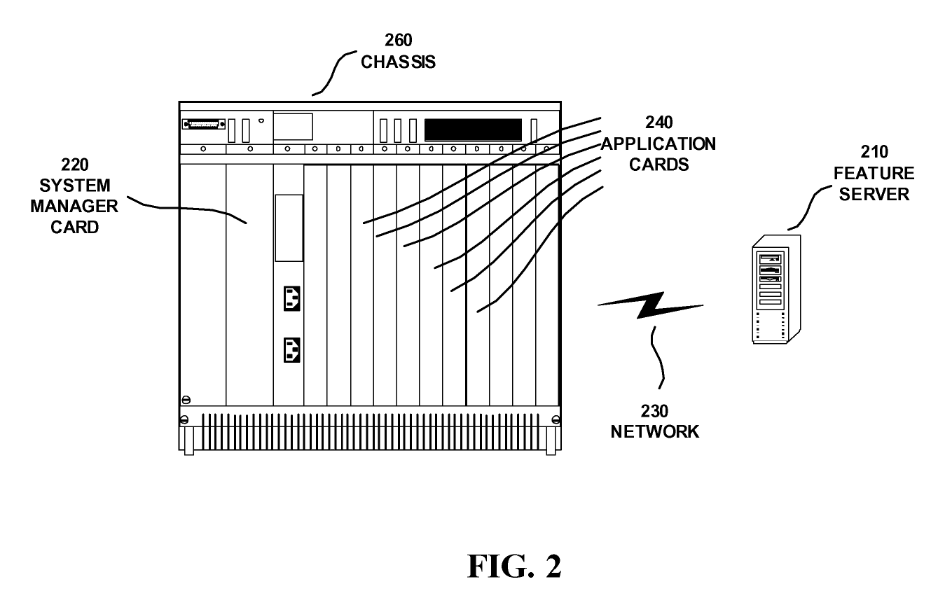

FIG. 2 illustrates a diagram of an embodiment of the present invention having a plurality of application cards 240, at least one system manager card 220 and a feature rights server 210 according to an embodiment of the present invention. A chassis 260 holds a plurality of application cards 240 and is capable of holding a system manager card 220. In a facility more than one chassis 260 can be deployed. In the event more than one chassis is deployed, only one system manager is needed. The feature rights server 210 communicates over a network 230 with the system manager card 220 in the facility. Typically the feature rights server 210 is located in a different city or building from the facility with the various chassis 260. The system manager card 220 receives element feature keys from the feature rights server 210 over the network 230. The application cards 240 then request permission to activate features from the system manager card 220. It is noted that the present invention is applicable to arrangements other than chassis structures with application cards. For example the sub-agents can be virtual software components operating on general-purpose computing platforms alongside a software feature rights management agent which provides permissions in a trusted environment. The feature rights server 210, however, would be located in a remote central location and needs digital authentication signature and its feature keys.

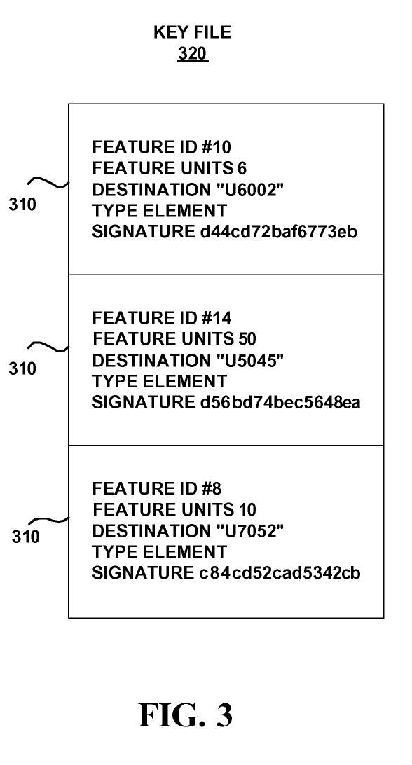

FIG. 3 illustrates a diagram of an example of a feature key file 320 containing the feature keys of the present invention. A plurality of feature keys 310 makeup a feature key file 320. Each feature key 310 contains a feature ID, a number of feature units, a destination identifier (such as a serial number or identifier for a feature server or feature rights management agent), a type of either element or network and a digital authentication signature.

Because the relationship between the feature rights management agent and sub-agent is trusted, permissions and not keys are communicated between the agent and sub-agents. These permissions do not contain a destination identifier or a digital authentication signature because they do not need the extra security provided by them in a key. The feature key file 320 can be encoded using Extensible Markup Language XML which provides a containment mechanism where each key 310 and its contents are uniquely identified by XML tags.

The feature rights server 110 is allowed to divide the feature units provided for in a key 310. For example, six feature units for a Feature ID of 10 can be allocated among two agents 120. For instance, a first agent 120 may receive three feature units for the feature ID 10 and a second agent 120 may receive one feature unit for this Feature ID 10 while the feature rights server 110 retains the remaining two feature units for the illustrated Feature ID 10. Once the feature rights server divides the units, it assembles a feature key 310 with a type designation of “element” as illustrated in FIG. 3. The “element” type designation identifies that the feature key now assembled by the feature server is a key for a feature rights management agent. The key 310 assembled by the feature rights server also specifies a destination ID for the feature rights management agent, the number of feature quantity units and the feature type of the key. The feature rights management agent does not assemble feature keys for delivery to the sub-agents. The feature rights management agent just provides permission to the sub-agents. Nevertheless, when the feature rights management agent returns feature rights to the feature server, the feature rights management agent assembles a key for their return.

The digital authentication signature of each feature key 310 is calculated using a hash function on the feature ID, feature units and destination identifier. This digital authentication signature also provides a secure authentication with the key source and also provides the same benefits as a checksum. The hash function can be any function that takes message authentication codes and combines them with a secret keyword. One preferred example of a hash function is the MD5 Keyed-Hash Message Authentication Code (HMAC MD5) and other kinds such as HMAC SHA-1 or HMAC RIPEMD can be used. A security parameter index can be contained in the feature key to identify the kind of hash or encryption function used to encode and decode the authentication signature.

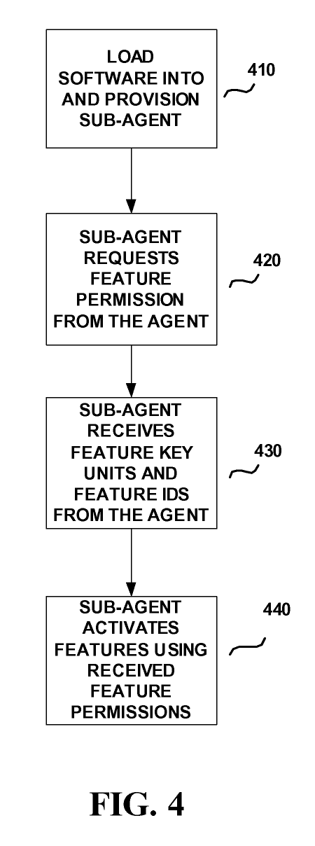

FIG. 4 illustrates a flowchart of a method where a sub-agent requests feature permissions from a feature rights management agent. An operator first sets up a sub-agent at step 410 by loading application software into the sub-agent such as an application card of the chassis in the preferred embodiment of FIG. 2. Typically all features are contained in the application software pre-loaded in a sub-agent, but the application software in the sub-agent requires permission before such features are activated. The operator at the facility then in step 410 provisions the sub-agent. After provisioning, certain features need permission. The sub-agent then requests at step 420 permission from the feature rights management agent for the new provisioning. The sub-agent at step 430 then receives a message from the feature rights management agent notifying the sub-agent that a quantity of feature key units for a particular feature as specified by a feature ID has been allocated to the sub-agent. The sub-agent at step 440 then activates the features using the received feature authorizations.

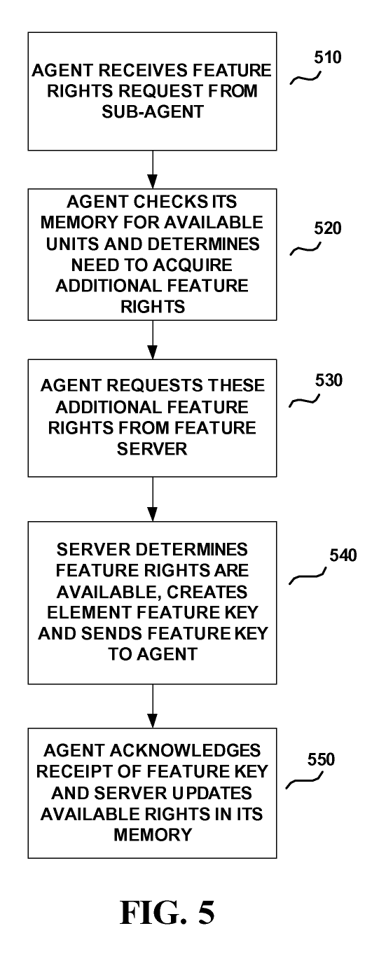

FIG. 5 illustrates a flowchart of a method where a feature rights management agent requests feature keys from a feature rights server. A feature rights management agent receives a feature rights request from a sub-agent in step 510. The feature rights management agent in step 520 checks its memory for available feature units and determines whether units are available. If units are not available, the feature rights management agent requests additional rights from the feature server as in step 530. The server in step 540 receives the request and evaluates the available feature rights and creates an element feature key and returns that element key to the feature rights management agent. The feature rights management agent in step 550 validates the contents of the feature key and acknowledges receipt to the server at which point the server updates its memory indicating that the feature rights have been allocated.

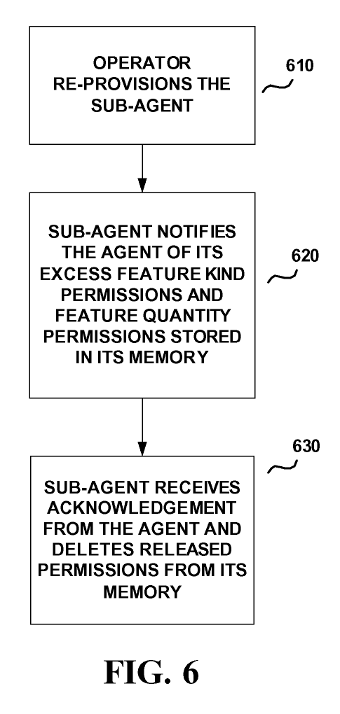

FIG. 6 illustrates a flowchart of a method where a sub-agent releases feature permissions to a feature rights management agent. An operator re-provisions a sub-agent at step 610. The sub-agent in step 620 releases its excess permissions to the feature rights management agent in response to the re-provisioning. The permissions released include its excess feature kind permissions and feature quantity permissions. The sub-agent then receives a release acknowledgment from the feature rights management agent and deletes released permissions from its memory at step 630.

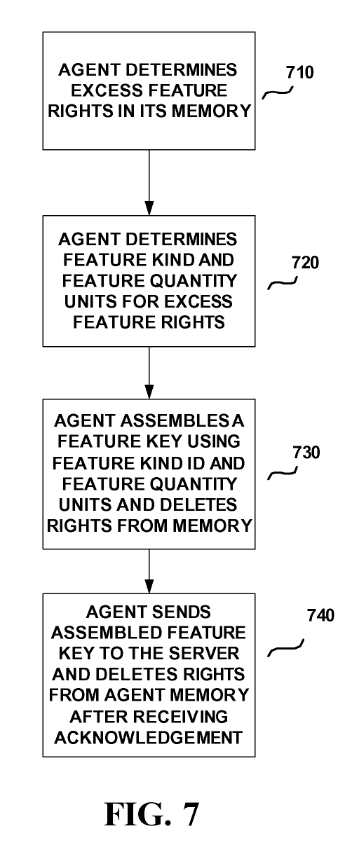

FIG. 7 illustrates a flowchart of a method where a feature rights management agent releases feature keys to a server. A feature rights management agent determines whether excess feature rights are stored in its memory at step 710. The feature rights management agent tracks in its memory for each kind of feature a quantity of feature units which have not been allocated to sub-agents. The feature rights management agent then determines at step 720 from memory the excess kinds of features and the excess quantity units for each kind of feature. Then at step 730 the feature rights management agent assembles an element feature key using a feature ID and using feature quantity units and deletes such rights from its memory. The feature rights management agent then sends at step 740 the assembled feature key to the feature rights server and deletes rights from its memory after receiving an acknowledgment from the feature rights server. This key sent to the feature rights server from the feature rights management agent is an element type of key.

Element keys are assembled for communication between the feature rights server and an agent. Network keys are loaded into the feature rights server when provided by an equipment supplier. Because the relationship between the feature rights management agent and the sub-agent is a trusted relationship, an authentication signature is not needed for communication of rights between the feature rights management agent and sub-agent. Thus keys are not needed and mere permissions can be communicated between a feature rights management agent and its sub-agents.

The present invention allows an operator of a facility to add or delete features at the sub-agent level such as by interacting directly with an application card in a chassis. Feature keys are purchased from an equipment supplier and loaded into a central feature rights server which can be remotely located. This multilevel hierarchy structure allows the rights to be added at a central location and the control of features determined at the bottom of the hierarchy. This has one advantage of little communication demand between application software and the feature rights server. The application software can have features enabled by merely obtaining a quantity units permission for that feature from a feature rights management agent located in the same facility, chassis or nearby chassis. Thus, communication over wide area network to a remote server is not necessary and reliability is improved. Telecommunications equipment should be capable of autonomously returning to an operational state without the need for authorizations from a remote node such as a feature rights server. Telecommunications networks should not be dependent upon authorizations from wide area network servers anymore than necessary in the event of network failure or national crisis. Management by the feature rights server is also simplified because the feature rights server has knowledge of only what feature rights management agents obtained feature key rights. The feature rights server and its operator are not burdened with the data of which sub-agents in the facilities have activated features. Thus the unique multilevel hierarchy for feature rights management having the above advantages is provided by the present invention as illustrated in the drawings and claimed herein below.

Although the invention has been described and illustrated in the above description and drawings, it is understood that this description is by example only, and that numerous changes and modifications can be made by those skilled in the art without departing from the true spirit and scope of the invention. Although the examples in the drawings depict only example constructions and embodiments, alternate embodiments are available given the teachings of the present patent disclosure. For example the embodiment of the feature rights management agents and sub-agents does not need to be implemented in any particular hardware configuration but could logically be separated while physically embodied in the same hardware. Additionally, while the invention has been illustrated as equipment deployed by an operator, other kinds of users can benefit from the present invention besides telecommunications operators.

1. A feature rights management system, comprising:
a feature rights server having a repository for storing feature keys, the feature keys representing activation rights for features;
a feature rights management agent operatively coupled to the feature rights server to receive feature keys from the feature rights server, to store feature rights in a repository, and to identify available feature units provided; and
a sub-agent operatively coupled to the feature rights management agent to request feature rights from the feature rights management agent, wherein the feature rights management agent allocates the feature units among requesting sub-agents.

2. A feature rights management system according to claim 1,
wherein the feature rights management agents and the feature rights server transfer rights between the feature rights management agents and the server in the form of keys; and
wherein the sub-agents and the feature rights management agent transfer rights between the sub-agents and the feature rights management agent in the form of permissions.

3. A feature rights management system according to claim 2,
wherein a connection between the feature rights management agents and the feature rights server is un-trusted; and
wherein a connection between the sub-agents and the feature rights management agent is trusted.

4. A feature rights management system according to claim 2, wherein the sub-agent requests permissions for feature rights from the feature rights management agent upon provisioning.

5. A feature rights management system according to claim 4,
wherein the feature rights management agent comprises a memory for storing a number of unallocated feature units; and
wherein the feature rights management agent requests keys for features from the feature rights server when the number of unallocated feature units is deficient to meet the needs of a request for permissions by a sub-agent.

6. A feature rights management system according to claim 3,
wherein the sub-agent releases a feature unit by sending a release message to the feature rights management agent; and
wherein the feature rights management agent increases its number of available feature units in response to the release message.

7. A feature rights management system according to claim 3, wherein the feature management agent releases feature keys from a feature rights management agent and moves feature rights keys to the feature rights server.

8. A feature rights management system according to claim 1, wherein each feature key comprises a plurality of feature rights including a) feature units, b) a feature category, and c) a distribution node identifier.

9. A feature rights management system according to claim 9, wherein each feature unit designates how many instances of a feature category is permitted within a domain of a distribution node identified by the distribution node identifier.

10. A feature rights management system according to claim 8, wherein the feature keys are of at least two kinds of keys: network keys destined to the feature rights server and element keys destined for the feature rights management agent.

11. A method of managing feature rights, comprising the steps of:
(a) storing feature keys in a feature rights server, the feature keys representing activation rights for features;
(b) receiving feature keys in a feature rights management agent from the feature rights server;
(c) storing the received feature keys in the agent to identify available feature; and
(d) requesting in a sub-agent feature rights from the feature rights management agent.

12. A method of managing feature rights according to claim 11, further comprising the step of
(e) receiving in the sub-agent feature rights from the feature rights management agent in the form of permissions.

13. A method of managing feature rights according to claim 12,
wherein said step (b) of receiving is over a un-trusted environment; and
wherein said step (e) of receiving permissions is over a trusted environment.

14. A method of managing feature rights according to claim 12,
wherein said step (d) of requesting requests permissions from the feature rights management agent for feature rights upon provisioning.

15. A method of managing feature rights according to claim 12, further comprising the steps of:
(f) releasing a feature unit from the sub-agent by sending a release message to the feature rights management agent; and
(g) increasing a number of available feature units in the feature rights management agent in response said step (f).

16. A method of managing feature rights according to claim 12, further comprising the step of
(f) moving feature rights keys from the feature management agent to the feature rights server to release feature keys from a feature rights management agent.

17. A method of managing feature rights according to claim 11, wherein each feature key comprises a plurality of feature rights including a) feature units, b) a feature category, and c) a distribution node identifier.

18. A method of managing feature rights according to claim 17, wherein each feature unit designates how many instances of a feature category is permitted within a domain of a distribution node identified by the distribution node identifier.

19. A feature rights management apparatus capable of managing feature keys and permissions representing activation rights for features, comprising:
a feature rights management agent operatively coupled to a feature rights server to receive feature keys, to store feature rights in a repository, and to identify available feature units provided; and
a sub-agent operatively coupled to the feature rights management agent to request feature rights from the feature rights management agent, wherein the feature rights management agent allocates the feature units among requesting sub-agents.

20. A feature rights management apparatus according to claim 19,
wherein the feature rights management agent and the feature rights server transfer rights between themselves in the form of keys; and
wherein the sub-agents and the feature rights management agent transfer rights between themselves in the form of permissions.

21. A feature rights management apparatus according to claim 20,
wherein a connection between the feature rights management agent and the feature rights server is un-trusted; and
wherein a connection between the sub-agents and the feature rights management agent is trusted.

22. A feature rights management apparatus according to claim 20, wherein the sub-agent requests permissions for feature rights from the feature rights management agent upon provisioning.

23. A feature rights management system according to claim 22,
wherein the feature rights management agent comprises a memory for storing a number of unallocated feature units; and
wherein the feature rights management agent requests keys for features from the feature rights server when the number of unallocated feature units is deficient to meet the needs of a request for permissions by a sub-agent.

24. A feature rights management apparatus according to claim 20,
wherein the sub-agent releases a feature unit by sending a release message to the feature rights management agent; and
wherein the feature rights management agent increases its number of available feature units in response to the release message.

25. A feature rights management apparatus according to claim 20, wherein the feature management agent releases feature keys from a feature rights management agent and moves feature rights keys to the feature rights server.

26. A feature rights management apparatus according to claim 19, wherein each feature key comprises a plurality of feature rights including a) feature units, b) a feature category, and c) a distribution node identifier.

27. A feature rights management apparatus according to claim 26, wherein each feature unit designates how many instances of a feature category is permitted within a domain of a distribution node identified by the distribution node identifier.

28. A feature rights management apparatus according to claim 26,
wherein the feature keys are of at least two kinds of keys: network keys destined to the feature rights server and element keys destined for the feature rights management agent;
wherein, the distribution node identifier of an element key identifies a domain of an identified feature rights management agent, and
wherein the distribution node identifier of a network key identifies a domain of an identified feature management server.

29. A feature rights management apparatus according to claim 19, further comprising a chassis housing the feature rights management agent and the sub-agents as cards.
